(19) United States
(12) Patent Application Publication
(10) Pub. No.: US 2025/0008945 A1
(43) Pub. Date: Jan. 9, 2025

(54) AUTOMATIC EMBALMING APPARATUS

(71) Applicant: Law Office of Jerry Joseph, PLC, Washington, DC (US)

(72) Inventor: Shelby Myers, Martinsburg, WV (US)

(21) Appl. No.: 18/760,181

(22) Filed: Jul. 1, 2024

Related U.S. Application Data
(60) Provisional application No. 63/524,774, filed on Jul. 3, 2023.

(51) Int. Cl. A01N 1/00

(52) U.S. Cl. CPC A01N 1/00

(57) ABSTRACT

An embalming apparatus including a plurality of solution reservoirs that each houses a unique embalming solution including a plurality of solution parts, and a plurality of solution part loading reservoirs that each houses a respective one of the solution parts. Each of the solution loading reservoirs are fluidly connected to each of the solution reservoirs. Each solution loading reservoir includes a respective loading pump that is operative to cause a volume of the solution part in the respective solution part loading reservoir to be transferred to at least one of the plurality of solution reservoirs. Further included is a controller is in operative connection with each of the loading pumps. The controller is configured to cause each pump to transfer a controller determined volume of the solution part in a respective solution part loading reservoir to at least one of the plurality of solution reservoirs.

### BACKGROUND OF THE INVENTION

### 1. Field of the Invention

The present general inventive concept relates to embalming devices, and more particularly, to embalming devices that have been developed to deliver embalming fluid into a cadaver.

### 2. Description of Related Art

There have been previous devices that have been developed that are used to inject embalming fluid into a cadaver through a variety of techniques. These previous devices and processes are time consuming to set up, labor intensive, and prone to human error.

Therefore, what is desired is an automatic embalming device that is simple to setup and use, and which reduces the potential for human error in the embalming process. Further desired is an automatic embalming device that enables an increase in the quantity of cadavers embalmed while maintaining a high quality of embalming.

### SUMMARY OF INVENTION

Exemplary embodiments provide an apparatus for embalming that may include a solution reservoir that includes an interior area configured to house an embalming solution comprised of a plurality of solution parts, a plurality of solution part loading reservoirs that each includes a respective interior area configured to house a respective one of the solution parts that comprise the embalming solution. Each solution loading reservoir interior area is fluidly connected to the solution reservoir, and each solution loading reservoir includes a respective loading pump that is operative to cause a volume of the solution part in the respective solution part loading reservoir to be transferred to the solution reservoir. Exemplary embodiments may further include a delivery line that is fluidly connected to the solution reservoir, includes at least one valve, and is in operative connection with a solution delivery device. The at least one valve is operative to control the flow of embalming solution to the solution delivery device, and the delivery device is configured to deliver embalming solution to cadavers. Exemplary embodiments may further include a controller that is in operative connection with each of the respective loading pumps and the delivery line valve. The controller is configured to cause each respective loading pump to transfer a controller determined volume of the solution part in a respective solution part loading reservoir to the solution reservoir, and the controller is operative to control the flow of embalming solution to the solution delivery device through operation of the valve.

Alternative embodiments may further include a delivery line sensor that is in operative connection with an interior area of the delivery line and is operative to continuously determine a pressure of the embalming solution flowing through the delivery line.

In alternative embodiments, the delivery line sensor is in operative connection with the interior area of the delivery line intermediate of the delivery line valve and the solution delivery device.

In alternative embodiments, the controller is in operative connection with the delivery line sensor. The controller is operative to receive from the delivery line sensor at least one signal indicating the pressure of the embalming solution flowing through the delivery line, and responsive to the at least one signal the controller is operative to vary the volume of embalming solution in the delivery line through operation of the delivery line valve intermediate of a valve open position and a valve closed position.

In alternative embodiments, the controller is in operative connection with an input device, the controller is operative to receive at least one input corresponding to a cadaver parameter through the input device, and responsive to the at least one input the controller is operative to determine a respective volume of each of the plurality of solution parts to be transferred into the solution reservoir.

In alternative embodiments, the controller is in operative connection with an output device. The output device is configured to provide an audible output, and responsive to receipt of a signal from the delivery line sensor indicating a high pressure of the embalming solution in the delivery line, the controller is operative to cause an audible output.

In alternative embodiments, the output device is further configured to provide a visual output, and the controller is operative to cause visual outputs to be visually displayed by the output device.

In alternative embodiments, the visual outputs include data corresponding to at least one of: a pressure of the embalming solution in the delivery line; a volume of the embalming solution in the solution reservoir; and a respective volume of each of the plurality of solution parts included in embalming solution in the solution reservoir.

In alternative embodiments, responsive to the input cadaver parameters the controller is operative to make a determination when the embalming process is complete, and responsive to the embalming process complete determination, the controller is configured to move the valve to the valve closed position.

In alternative embodiments, the apparatus may further include a plurality of solution reservoirs, each solution reservoir: is configured to house a unique embalming solution based on cadaver parameters for one cadaver of a plurality of cadavers; is fluidly connected with each of the plurality of solution loading reservoirs; and includes a respective delivery line, delivery line valve, delivery line sensor, and delivery device. The controller is operative to control the flow of the solution parts into each of the plurality of solution reservoirs and to control the flow of the embalming solution through the respective delivery line of each of the plurality of solution reservoirs.

Exemplary embodiments further provide an apparatus for embalming that may include a solution reservoir that houses an embalming solution including a plurality of solution parts, a plurality of solution part loading reservoirs that each houses a respective one of the solution parts. Each solution loading reservoir is fluidly connected to the solution reservoir, and each solution loading reservoir includes a respective loading pump, wherein each loading pump is operative to cause a volume of the solution part in the respective solution part loading reservoir to be transferred to the solution reservoir. Exemplary embodiments may further include a controller that is in operative connection with each of the respective loading pumps. The controller is configured to cause each respective loading pump to transfer a controller determined volume of the solution part in a respective solution part loading reservoir to the solution reservoir.

In alternative embodiments, the apparatus may further include a delivery line that is fluidly connected to the solution reservoir, includes at least one valve, and is in operative connection with a solution delivery device. The at least one valve is operative to control the flow of embalming solution to the solution delivery device, and the delivery device is configured to deliver embalming solution to cadavers.

In exemplary embodiments, the controller is in operative connection with the delivery line valve is operative to control the flow of embalming solution to the solution delivery device through operation of the valve.

In alternative embodiments the apparatus may further include a delivery line sensor in operative connection with the delivery line. The delivery line sensor is operative to periodically determine a pressure of the embalming solution flowing through the delivery line.

In alternative embodiments, the controller is operative to receive from the delivery line sensor at least one signal indicating the pressure of the embalming solution in the delivery line, and responsive to the at least one signal the controller is operative to vary a position of the valve intermediate of a valve open position and a valve closed position.

In alternative embodiments, the controller is in operative connection with an input device, the controller is operative to receive at least one input corresponding to a cadaver parameter through the input device, and responsive to the at least one input the controller is operative to determine and cause to be transferred to the solution reservoir a respective volume of each of the plurality of solution parts.

In alternative embodiments, the controller is in operative connection with an output device configured to provide an audible output, and responsive to receipt of a signal from the delivery line sensor indicating a high pressure of the embalming solution in the delivery line, the controller is operative to cause an audible output.

In alternative embodiments, the output device is further configured to provide a visual output, and the controller is operative to cause visual outputs to be visually displayed by the output device.

In alternative embodiments, responsive to the input cadaver parameters the controller is operative to make a determination when the embalming process is complete, and responsive to the embalming process complete determination, the controller is configured to cease the flow of embalming solution from the solution reservoir to the delivery line.

Alternative embodiments may further provide an embalming apparatus including a plurality of solution reservoirs where each solution reservoir houses a unique embalming solution including a plurality of solution parts, a plurality of solution part loading reservoirs that each houses a respective one of the solution parts. Each of the solution loading reservoirs are fluidly connected to each of the plurality of solution reservoirs.

Each solution loading reservoir includes a respective loading pump, and each loading pump is operative to cause a volume of the solution part in the respective solution part loading reservoir to be transferred to at least one of the plurality of solution reservoirs. The exemplary embodiment may further include a controller that is in operative connection with each of the respective loading pumps. The controller is configured to cause each respective loading pump to transfer a controller determined volume of the solution part in a respective solution part loading reservoir to at least one of the plurality of solution reservoirs.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 is a front perspective view of an automatic embalming apparatus according to an embodiment of the present inventive concept;

FIG. 2 illustrates a rear perspective view of the automatic embalming apparatus illustrated in FIG. 1;

FIG. 3 is a bottom perspective view of the automatic embalming apparatus illustrated in FIG. 1;

FIG. 4 is a bottom plan view of the automatic embalming apparatus illustrated in FIG. 1; and

FIG. 5 is a right-side perspective view of the display screen and the input device illustrated in FIG. 1.

### DETAILED DESCRIPTION OF INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

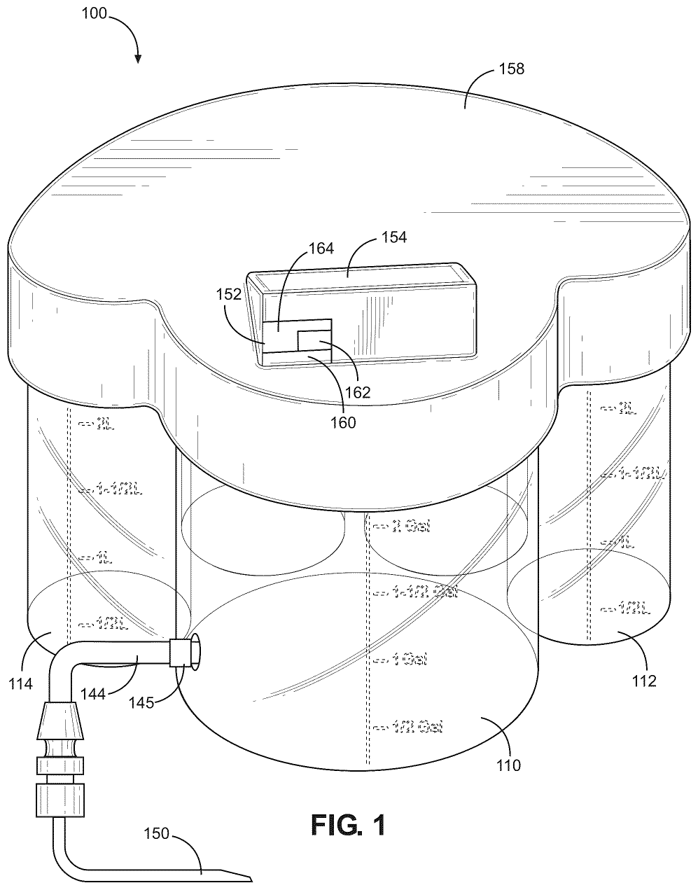

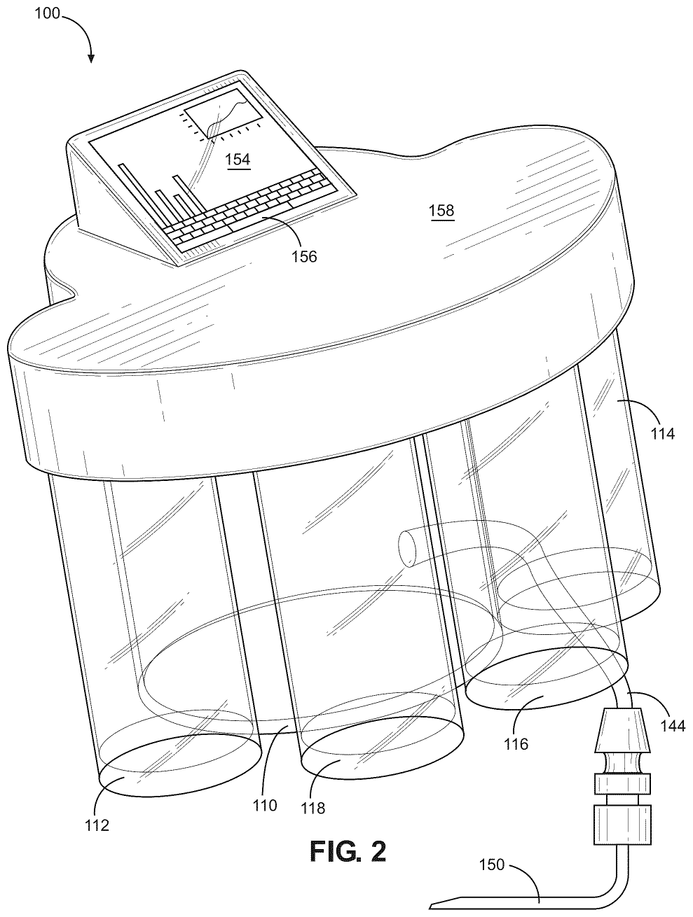

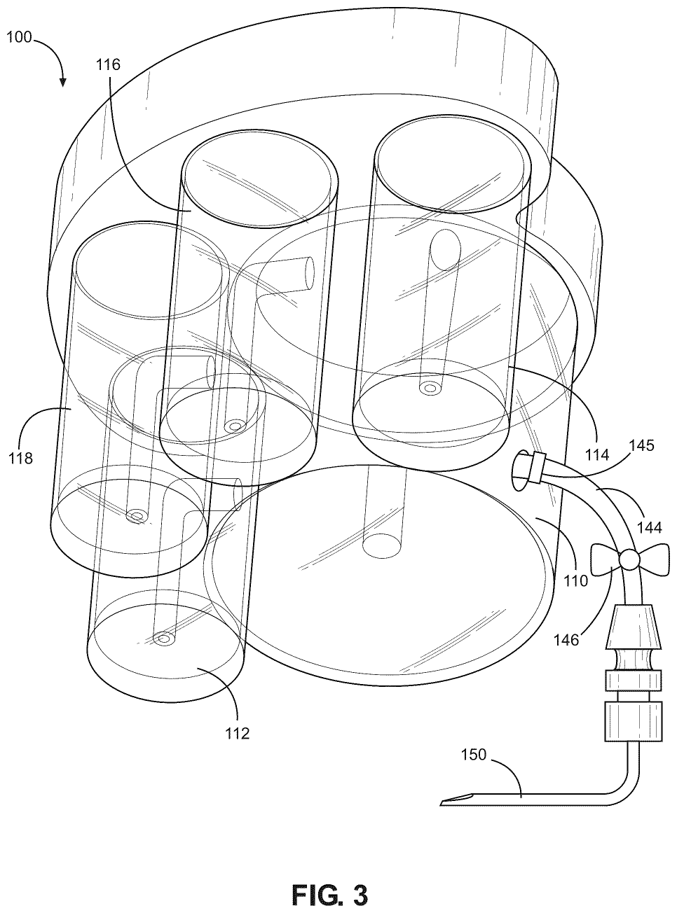

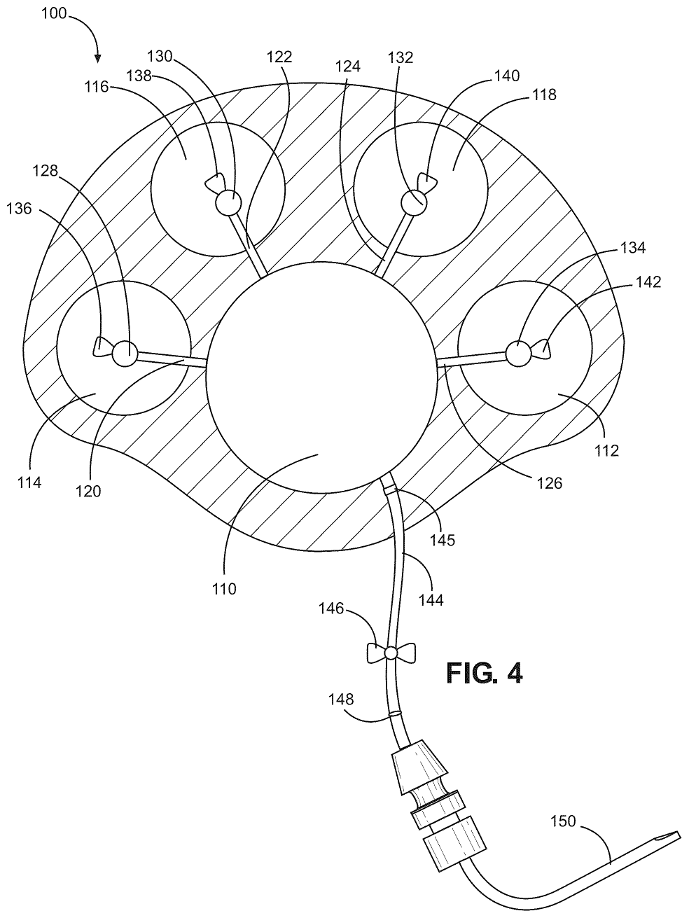

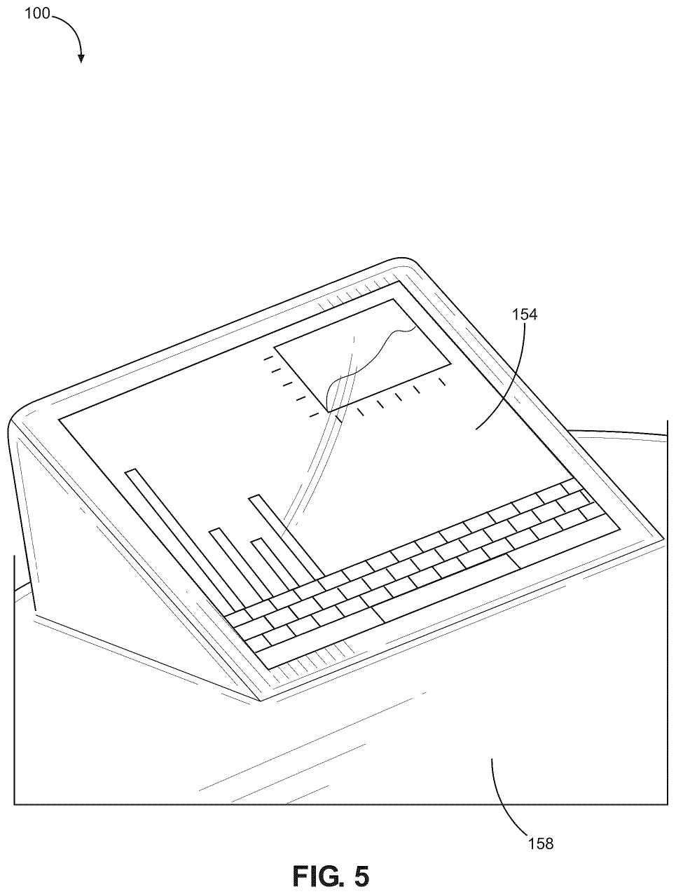

FIG. 1 is a front perspective view of an automatic embalming apparatus according to an embodiment of the present inventive concept. FIG. 2 illustrates a rear perspective view of the automatic embalming apparatus illustrated in FIG. 1. FIG. 3 is a bottom perspective view of the automatic embalming apparatus illustrated in FIG. 1. FIG. 4 is a bottom plan view of the automatic embalming apparatus illustrated in FIG. 1. FIG. 5 is a right-side perspective view of the automatic embalming apparatus illustrated in FIG. 1.

Referring to FIGS. 1 through 5, the automatic embalming apparatus, designated generally as 100, is illustrated. In the present embodiment, the automatic embalming apparatus 100 is designed and configured to reduce potential human error in the embalming process, as well as to increase the quantity of cadavers that can be embalmed while maintaining a high quality of embalming.

The automatic embalming apparatus 100 according to the present invention includes a solution reservoir 110, a plurality of fluid loading reservoirs 112, 114, 116, 118, a plurality of transfer tubes 120, 122, 124, 126, a plurality of loading pump lines 128, 130, 132, 134, a plurality of loading pumps 136, 138, 140, 142, a solution delivery line 144, a delivery line valve 146, a delivery line sensor 148, an embalming cannula 150, a control system or controller 152, a display screen 154, an input device 156, and a removable lid 158. However, the present general inventive concept is not limited thereto.

In the present embodiment, the solution reservoir 110 includes an interior area that is configured to hold embalming solution. The exemplary embalming solution is comprised of a mixture of embalming solution parts or fluids, including but not limited to, formaldehyde, water, and chemicals. Embalming solution parts may also include solid, semi-solid, or powder mixtures as well. However, the present general inventive concept is not limited thereto.

As best shown in FIG. 4., the exemplary fluid loading reservoirs, also referred to herein as solution part loading reservoirs, 112, 114, 116, and 118 each include an interior area that is configured to hold one or a mixture of the embalming solution parts that make up the embalming solution. The exemplary fluid loading reservoirs 112-118 each include a respective transfer tube 120, 122, 124, or 126. The exemplary transfer tubes 120-126 extend from the interior area of the fluid loading reservoirs into the interior area of the solution reservoir 110 to fluidly connect the respective loading reservoir 112-118 and the solution reservoir 110. The transfer tubes 120-126 are configured to enable the fluid in the loading reservoirs 112-118 to be delivered into the solution reservoir 110 to create the embalming solution.

Still referring to FIG. 4, the loading reservoirs 112-118 each include a respective loading pump line 128, 130, 132, and 134 and a respective loading pump 136, 138, 140, and 142. The pump lines 128-134 are in fluid connection with the interior area of the loading reservoirs and with the respective transfer tubes 120-126. During operation, the loading pumps 136-140 are configured to draw fluid from the respective loading reservoir 112-118 through the respective pump line 128-134, and to deliver the fluid into the solution reservoir 110 through the respective transfer tubes 120-126.

The automatic embalming apparatus 100 further includes a solution delivery line 144 in operative fluid connection with the interior area of the solution reservoir 110. The solution delivery line 144 includes a delivery line pump 145, a delivery line valve 146, a delivery line sensor 148, and an embalming cannula 150.

The delivery line pump 145 is configured to draw embalming solution from the solution reservoir 110 into the delivery line 144 for delivery to the cadaver. The valve 146 is configured to control the flow through the delivery line 144. The sensor 148 is configured to periodically determine a pressure of an interior of the delivery line 144. The cannula 150 is configured to be inserted into an artery of the cadaver and to deliver the embalming solution thereto.

In the present embodiment, the control system or controller 152 is programmed to automatically adjust the amount of embalming fluid that is pumped into the body and to regulate the temperature and pressure of the embalming fluid. However, the present general inventive concept is not limited thereto.

As best shown in FIGS. 1 and 5, the control system or controller 152 includes or is in operative connection with at least one processor 160, a memory or non-transitory memory 162, and at least one circuit 164. The exemplary control system or controller 152 is in operative connection with the loading pumps 136-142, the delivery line pump 145, the valve 146, and the delivery line sensor 148. The exemplary control system or controller 152 may be in wired connection with the various pumps and sensors via the circuit 164, or the control system or controller 152 may be configured to wirelessly communicate with the various pumps, valves, and sensors. For example, the control system or controller 152 may be configured to switch the pumps between on and off positions, continuously communicate with and monitor sensor data, and change valves between open and closed positions either through a wired connection or wirelessly.

The memory 162 is configured to store processor readable instructions for achieving the operations and functions of the device 100. The processor 160 is configured to execute the processor readable instructions of the memory 162 in order to cause the control system or controller 152 to cause the operations and functions of the apparatus 100.

The present embodiment further includes an output device or a display screen 154 and an input device 156. The display screen 154 and the input device are in operative connection with the control system or controller 152 either via the circuit 164 or wirelessly. The display screen 154 is operative to display an output in response to the control system or controller 152. The input device 156 is configured to enable an operator to input information into the control system or controller 152, for example, information corresponding to cadaver parameters, including, but not limited to, the cadaver weight, skin tone, or other cadaver related information. However, the present general inventive concept is not limited thereto.

In the present embodiment, responsive to the cadaver parameters input into the control system or controller 152, the control system or controller 152 is operative to cause the loading pumps 136-142 to draw liquid from the loading reservoirs 112-118 into the solution reservoir 110 to create a unique embalming solution specific to the cadaver parameters of the cadaver being worked on. The control system or controller 152 is configured to cause the delivery line pump 145 to draw the liquid out of the solution reservoir 110, through the delivery line 144, and introduce the embalming solution into the cadaver artery via the cannula 150.

The control system or controller 152 is configured to monitor the delivery line 144 by communicating with the sensor 148 to determine whether there is a pressure build up in the delivery line 144, for example responsive to a clogged vein or artery of the cadaver due to a blood clot.

The control system or controller 152 is configured to automatically stop the delivery of embalming solution to the cadaver in response to a pressure build up in the delivery line 144 responsive to data received from sensor 148. The control system or controller 152 is configured to stop the delivery of embalming solution by at least one of stopping pump 145 or closing valve 146. Further, the control system or controller 152 is configured to automatically stop the delivery of embalming solution to the cadaver once the control system or controller 152 determines the embalming process has been completed based on the cadaver parameters or cadaver related information input into the system or controller 152.

In alternative embodiments, the control system or controller 152 may output an alert via an audible or visual output device in operative connection with the control system or controller 152 when the system or controller 152 determines a pressure build up in the delivery line 144 or when the control system or controller 152 determines the embalming process has been completed, thereby alerting the operator of potential damage to the cadaver and the apparatus 100 or of completion of the embalming process.

Alternatively, the control system or controller 152 may communicate a message to an electronic mobile device of the operator if there is a pressure build up, or when the control system or controller 152 determines the embalming process has been completed. In such embodiments, the control system or controller 152 may include a transceiver and the controller 152 is configured to communicate wirelessly with remote electronic devices through at least one telecommunications network.

In alternative embodiments, the device 100 may further include fluid level and temperature sensors included in the interior areas of the solution reservoir 110 and the loading reservoirs 112-118. These additional sensors are in operative connection with the control system or controller 152.

In alternative embodiments, the apparatus 100 is not limited to the number of loading reservoirs and solution reservoirs shown and described. That is, in alternative embodiments, the apparatus 100 may include any number of loading reservoirs and any number of solution reservoirs such that multiple cadavers can be embalmed by control system or controller 152 simultaneously. For example, in an alternative embodiment, the apparatus 100 may include five (5) solution reservoirs, each containing an embalming solution or a unique embalming solution for a respective one (1) of five (5) cadavers, and the control system or controller 152 is configured to monitor and complete the embalming process for each of the cadavers. As can be appreciated, such embodiments will also include additional features and relationships or duplicates of features and relationships discussed herein to achieve the functions and operations of the alternative embodiments.

In alternative embodiments, the device 100 may further include a drain reservoir and a drain tube. The exemplary drain tube is inserted into a vein of the cadaver and enables blood to move out of the cadaver veins through the drain tube and collect in the drain reservoir. The exemplary drain tube may include pressure sensors therein and the drain reservoir may include a fluid level sensor.

In alternative embodiments, the device 100 may further include a camera or scanner in operative connection with the control system or controller 152 that is operative to automatically determine the skin tone of the cadaver.

Although a few exemplary embodiments of the present general inventive concept have been illustrated and described, it will be appreciated by those skilled in the art that changes may be made in these exemplary embodiments and other embodiments may be made from the various features and relationships without departing from the principles and spirit of the general inventive concept, the scope of which is defined in the appended claims and their equivalents.

I claim:

1. An apparatus for embalming, comprising:
a solution reservoir, wherein the solution reservoir includes an interior area configured to house an embalming solution, wherein the embalming solution comprises a plurality of solution parts, a plurality of solution part loading reservoirs, wherein each solution part loading reservoir includes a respective interior area configured to house a respective one of the solution parts that comprise the embalming solution,
wherein each solution loading reservoir interior area is fluidly connected to the solution reservoir, and
wherein each solution loading reservoir includes a respective loading pump, wherein each loading pump is operative to cause a volume of the solution part in the respective solution part loading reservoir to be transferred to the solution reservoir,
a delivery line, wherein the delivery line is fluidly connected to the solution reservoir, includes at least one valve, and is in operative connection with a solution delivery device,
wherein the at least one valve is operative to control the flow of embalming solution to the solution delivery device, and wherein the delivery device is configured to deliver embalming solution to cadavers,
a controller, wherein the controller is in operative connection with each of the respective loading pumps and the delivery line valve,
wherein the controller is configured to cause each respective loading pump to transfer a controller determined volume of the solution part in a respective solution part loading reservoir to the solution reservoir, and
wherein the controller is operative to control the flow of embalming solution to the solution delivery device through operation of the valve.

2. The embalming apparatus according to claim 1, further comprising: a delivery line sensor, wherein the delivery line sensor is in operative connection with an interior area of the delivery line, and wherein the delivery line sensor is operative to continuously determine a pressure of the embalming solution flowing through the delivery line.

3. The embalming solution according to claim 2, wherein the delivery line sensor is in operative connection with the interior area of the delivery line intermediate of the delivery line valve and the solution delivery device.

4. The embalming apparatus according to claim 3, wherein the controller is in operative connection with the delivery line sensor, wherein the controller is operative to receive from the delivery line sensor at least one signal indicating the pressure of the embalming solution flowing through the delivery line, and responsive to the at least one signal the controller is operative to vary the volume of embalming solution in the delivery line through operation of the delivery line valve intermediate of a valve open position and a valve closed position.

5. The embalming apparatus according to claim 4, further comprising: wherein the controller is in operative connection with an input device,
wherein the controller is operative to receive at least one input corresponding to a cadaver parameter through the input device, and
wherein responsive to the at least one input the controller is operative to determine a respective volume of each of the plurality of solution parts to be transferred into the solution reservoir.

6. The embalming apparatus according to claim 5, wherein the controller is in operative connection with an output device, wherein the output device is configured to provide an audible output, and wherein responsive to receipt of a signal from the delivery line sensor indicating a high pressure of the embalming solution in the delivery line, the controller is operative to cause an audible output.

7. The embalming apparatus according to claim 6, wherein the output device is further configured to provide a visual output, wherein the controller is operative to cause visual outputs to be visually displayed by the output device.

8. The embalming apparatus according to claim 7, wherein the visual outputs include data corresponding to at least one of:
a pressure of the embalming solution in the delivery line;
a volume of the embalming solution in the solution reservoir; and
a respective volume of each of the plurality of solution parts included in the embalming solution in the solution reservoir.

9. The embalming apparatus according to claim 8, wherein responsive to the input cadaver parameters the controller is operative to make a determination when the embalming process is complete, and wherein responsive to the embalming process complete determination, the controller is configured to move the valve to the valve closed position.

10. The embalming apparatus according to claim 9, further comprising a plurality of solution reservoirs, wherein each solution reservoir:
is configured to house a unique embalming solution based on cadaver parameters for one cadaver of a plurality of cadavers;
is fluidly connected with each of the plurality of solution loading reservoirs; and
includes a respective delivery line, delivery line valve, delivery line sensor, and delivery device;
wherein the controller is operative to control the flow of the solution parts into each of the plurality of solution reservoirs and to control the flow of the embalming solution through the respective delivery line of each of the plurality of solution reservoirs.

11. An apparatus for embalming, comprising:
a solution reservoir, wherein the solution reservoir houses an embalming solution including a plurality of solution parts,
a plurality of solution part loading reservoirs, wherein each solution part loading reservoir houses a respective one of the solution parts,
wherein each solution loading reservoir is fluidly connected to the solution reservoir, and
wherein each solution loading reservoir includes a respective loading pump, wherein each loading pump is operative to cause a volume of the solution part in the respective solution part loading reservoir to be transferred to the solution reservoir,
a controller, wherein the controller is in operative connection with each of the respective loading pumps,
wherein the controller is configured to cause each respective loading pump to transfer a controller determined volume of the solution part in a respective solution part loading reservoir to the solution reservoir.

12. The apparatus according to claim 11, further comprising: a delivery line, wherein the delivery line is fluidly connected to the solution reservoir, includes at least one valve, and is in operative connection with a solution delivery device,
wherein the at least one valve is operative to control the flow of embalming solution to the solution delivery device, and wherein the delivery device is configured to deliver embalming solution to cadavers.

13. The apparatus according to claim 12, wherein the controller is in operative connection with the delivery line valve, and wherein the controller is operative to control the flow of embalming solution to the solution delivery device through operation of the valve.

14. The embalming apparatus according to claim 13, further comprising: a delivery line sensor in operative connection with delivery line, wherein the delivery line sensor is operative to periodically determine a pressure of the embalming solution flowing through the delivery line.

15. The embalming apparatus according to claim 14, wherein the controller is operative to receive from the delivery line sensor at least one signal indicating the pressure of the embalming solution in the delivery line, and responsive to the at least one signal the controller is operative to vary a position of the valve intermediate of a valve open position and a valve closed position.

16. The embalming apparatus according to claim 15, wherein the controller is in operative connection with an input device, wherein the controller is operative to receive at least one input corresponding to a cadaver parameter through the input device,
wherein responsive to the at least one input the controller is operative to determine and cause to be transferred to the solution reservoir a volume of each of the plurality of solution parts.

17. The embalming apparatus according to claim 16, wherein the controller is in operative connection with an output device configured to provide an audible output, and wherein responsive to receipt of a signal from the delivery line sensor indicating a high pressure of the embalming solution in the delivery line, the controller is operative to cause an audible output.

18. The embalming apparatus according to claim 17, wherein the output device is further configured to provide a visual output, wherein the controller is operative to cause visual outputs to be visually displayed by the output device.

19. The embalming apparatus according to claim 18, wherein responsive to the input cadaver parameters the controller is operative to make a determination when the embalming process is complete, and wherein responsive to the embalming process complete determination, the controller is configured to cease the flow of embalming solution from the solution reservoir to the delivery line.

20. An apparatus for embalming, comprising:
a plurality of solution reservoirs, wherein each solution reservoir houses a unique embalming solution including a plurality of solution parts,
a plurality of solution part loading reservoirs, wherein each solution part loading reservoirs houses a respective one of the solution parts,
wherein the solution loading reservoirs are fluidly connected to each of the plurality of solution reservoirs, and
wherein each solution loading reservoir includes a respective loading pump, wherein each loading pump is operative to cause a volume of the solution part in the respective solution part loading reservoir to be transferred to at least one of the plurality of solution reservoirs, a controller, wherein the controller is in operative connection with each of the respective loading pumps,
wherein the controller is configured to cause each respective loading pump to transfer a controller determined volume of the solution part in a respective solution part loading reservoir to at least one of the plurality of solution reservoirs.
